(19) United States
(12) Patent Application Publication
(10) Pub. No.: US 2019/0009529 A1
(43) Pub. Date: Jan. 10, 2019

(54) TEMPERATURE MEASUREMENT IN A HIGH TEMPERATURE FLUID JETTING DEVICE

(71) Applicant: Océ Holding B.V., Venlo (NL)

(72) Inventor: Hermanus H. VAN DER MEIJS, Venlo (NL)

(73) Assignee: Océ Holding B.V., Venlo (NL)

(21) Appl. No.: 16/023,746

(22) Filed: Jun. 29, 2018

(30) Foreign Application Priority Data
Jul. 7, 2017 (EP) 17180211.9

(51) Int. Cl. B41J 2/045; G01K 7/16; G01K 13/02

(52) U.S. Cl. CPC B41J 2/04563; G01K 13/02; G01K 7/16

(57) ABSTRACT

An accurate and compact device for controlling heating of a material in the fluid chamber of a metal droplet jetting device includes a pair of sensors in contact with the material in the fluid chamber. By transmitting a controlled current through the material and detecting the generated voltage across the electrodes (or vice versa), a measure for the resistance of the material is determined. The resistance is temperature-dependent and a good indicator for phase changes in a material. By continually monitoring a resistance related parameter, the heating of the material may be efficiently controlled to maintain the material in its liquid phase during operation.

### BACKGROUND OF THE INVENTION

### 1. Field of the Invention

The present invention relates to a device for ejecting droplets of a fluid having a high temperature such as a molten metal or a molten semiconductor.

### 2. Description of Background Art

From U.S. Pat. No. 5,831,643 it is known that a molten metal may be ejected in relatively small droplets using a force well known as a Lorentz force. The Lorentz force results from an electric current flowing through the metal, while being arranged in a magnetic field. A direction and magnitude of the resulting force is related to the cross product of the electric current and the magnetic field vector:

[symbol]

Sufficient heating is required to prevent the liquid metal from solidifying inside the device, thereby hindering operation of the device. Accurate determination of the liquid metal's temperature is required to ensure the metal remains heated above its melting point. Thereto, U.S. Pat. No. 5,831,643 provides a temperature sensor with a negative temperature coefficient, such that the internal resistance of the of the temperature sensor increases as the temperature exceeds a predefined reference value. To ensure contact with the liquid metal, the temperature sensor is mounted inside the fluid passage way of the device adjacent the liquid metal The liquid metal flows around the temperature sensor. The temperature sensor in U.S. Pat. No. 5,831,643 is structurally complex and expensive. Generally printing systems with large numbers of multiple parallel jetting devices are applied, so application of U.S. Pat. No. 5,831,643 would significantly affect the costs of such a printing system. Further, the temperature sensor in U.S. Pat. No. 5,831,643 partially obstructs the passage way, increasing the fluid resistance of the device.

### SUMMARY OF THE INVENTION

It is an object of the present invention to provide a simple fluid jet device configured to accurately control a temperature and/or phase of the material inside.

In a first aspect, the present invention provides a device for ejecting droplets of an electrically conductive fluid according to claim 1. The device comprises:
a fluid chamber body defining a fluid chamber and having an orifice extending from the fluid chamber to an outer surface of the fluid chamber body; and
an actuator for ejecting a droplet of the fluid from the fluid chamber and through the orifice;
a controller configured for receiving a signal from a sensor and for determining a temperature parameter of the fluid from the received signal,
   wherein the sensor is configured for sensing a resistance signal from the fluid and comprises a pair of spaced apart electrodes:
which electrodes are positioned such that fluid is flowable between the electrodes; and
which electrodes are arranged for passing an electrical current through fluid between the electrodes.

It is the insight of the inventors that the temperature of the fluid can be derived from the resistance of the fluid. The first and second electrodes are positioned at a distance from one another. The electrodes define a fluid passage through which fluid may pass. When a voltage is applied between the electrodes, a current passes between the electrodes through the fluid in the fluid passage. Alternatively, a current may be applied through the fluid in the fluid passage to generate a voltage different between the electrodes. By using Ohm's law, the resistance or resistivity of the fluid in the fluid passage can be easily derived from the voltage and current signals. The derived resistance is a measure for the temperature of the liquid. The measured signal can also be used to determine the phase of the material in the fluid chamber. As such, the temperature or phase of the material can be accurately controlled e.g. by controlling the heating in the device to achieve a substantially constant resistance related to the liquid phase. The resistance can further be used to determine an accurate value of the temperature of the liquid by comparing the resistance for the applied material to a look-up table. The present invention allows for accurate determination of the temperature of the liquid as well as for identifying a phase change in the material. This allows for an accurate control of the temperature and/or phase of the material.

The electrodes may be provided as any manner of suitable electrically conductive structures and positioned anywhere on the device, e.g. at the side faces of the fluid chamber. The electrodes are relatively simply to apply. In a particularly advantageous embodiment, the actuation electrodes already present in a jetting device may be used, resulting in a low cost solution which accurately determines the temperature of the liquid at or near the orifice. Thereby, the object of the present invention has been achieved.

More specific optional features of the invention are indicated in the dependent claims.

In an embodiment, the temperature parameter is indicative of a temperature or phase of the material in the fluid chamber. The temperature parameter may thus comprise a temperature, a resistance, or a phase parameter. Preferably, the temperature parameter corresponds a phase of the material, specifically to a temperature of the material.

In an embodiment, the sensor further comprises a resistance detector connected to the electrodes for sensing a resistance signal representative of the electrical resistance of the fluid between the electrodes. The sensor is thereby configured to determine a resistance parameter indicative of the electrical resistance of the fluid between the electrodes. As the resistance is temperature-dependent, it provides a measure for the temperature of the fluid. The detector may comprise a look-up table stored in its memory to match a temperature value to the determined resistance. It is the insight of the inventors that the resistance of suitable materials for printing, e.g. metals, changes drastically during the solid-liquid phase transition of the material. The detector may be configured to monitor for such a change in the resistance to determine a phase transition. As such, the sensor may control a heater to maintain the material above its melting temperature. It will be appreciated that the resistance signal may comprise or be a resistivity signal. In one example, the controller is configured to derive the resistivity from the resistance signal e.g. by taking into account the geometric configuration of the electrodes or the volume of the fluid chamber.

In another embodiment, the sensor according to the present invention further comprises:
a generator for generating at least one of an electrical current or voltage signal extending between the electrodes; and
a detector for sensing at least the other of the electrical current and voltage signal extending between the electrodes,

wherein the controller is configured for comparing the generated signal to the sensed signal to determine an electrical resistance parameter of the fluid between the electrodes.

Resistance or resistance of a material may be easily determined by Ohm's law when a voltage difference over and a current through said object are known. Thereto, the sensor comprises a current source for generating a predefined electrical current through the liquid between the electrodes. The sensor comprises a voltage detector which senses the voltage difference between the electrodes. By receiving signals or values for the current and the voltage difference from the sensor, the controller is configured to determine a resistance parameter of the liquid between the electrodes. The controller may apply information regarding the dimensions of the device according to the present invention to determine e.g. a resistance of the material between the electrodes. The controller is configured to at least temporarily store data provided by the sensor over time for monitoring the resistance of the material between the electrodes. Preferably, the controller comprises a control loop for controlling a heater to maintain the material between the electrodes at a desired or predefined setting of the sensed resistance parameter. It will be appreciated that comparing the voltage and current may imply a mathematical operation such as division in accordance with Ohm's law or a timing comparison wherein a suitable voltage is selected for a period wherein the current has stabilized or has other otherwise reached a sufficiently suitable level for accurate detection.

In a further embodiment, the electrodes of the sensor are positioned on opposite sides of a fluid passage. In one example, the electrodes are provided on opposing sides of the fluid chamber. Preferably, the electrodes are provided at or near the orifice where the liquid is jetted from the fluid chamber onto a receiving medium. Thereby, the sensor is arranged to determine a temperature parameter of the material at or near the orifice. This ensures a proper functioning of the device as the phase (liquid or solid) of the material at or near the orifice may be directly derived from the sensor data. Heating of the device according to the present invention may then be accurately controlled to ensure liquidity of the material at the orifice during operation. This prevents blocking off the orifice. By accurately determining the phase of the material at the orifice, power consumption of the heater is reduced. The material may thus be kept at a temperature close to the melting temperature of the material without the risk of blocking the orifice. In turn, the wear on the additional components of the device according to the present invention is reduced, as the overall operating temperature may be reduced.

In an embodiment, the actuator comprises at least two electrically conductive actuation electrodes. Each actuation electrode is arranged, such that one end of each actuation electrode is in electrical contact with the fluid in the fluid chamber. The device according to the present invention comprises an actuator comprising the actuation electrodes in combination with a means for generating a magnetic field. The actuator is thus configured for jetting a droplet of the liquid from the fluid chamber by applying a current pulse to the actuator electrodes. Preferably, the actuator electrodes are positioned at or near the orifice. Thereby, a controlled and dosed release of the liquid is achieved.

In a preferred embodiment, the electrodes of the sensor are formed by the actuation electrodes. No additional electrodes are then required for sensing the resistance. The current generator is configured to generate a current pulse through the material between the electrodes for jetting a droplet from the fluid chamber. It is the insight of the inventors that then, by simultaneously measuring the voltage across the electrode, a resistance parameter of the material may be determined. Said resistance parameter provides an indicator for the temperature or phase of the material between the electrodes. By using the same electrodes for actuation of the droplet as for determining the resistance a simple and low-cost device is achieved.

In a further embodiment, the electrodes are pin-shaped and wherein an electrode is arranged in a through hole in the fluid chamber body, the through hole extending from an outer surface into the fluid chamber. The electrodes both extend into the fluid chamber body through a suitable through hole such that at least a tip of each of the electrodes is in direct electrical contact with the molten metal present in the fluid chamber.

In a preferred embodiment, the controller is configured to:
transmit an actuation pulse through the electrodes for jetting a droplet of the fluid from the orifice, which actuation pulse comprises a constant current portion; and
determining the temperature parameter of the fluid by comparing the constant current portion to a signal portion received from the sensor in response to the constant current portion.

Preferably, the current generator is arranged to generate a current pulse comprising a constant or stabilized current portion or section. The controller is then configured to compare the sensed voltage from the voltage detector corresponding to the constant current portion to determine the resistance parameter. Thereby, the accuracy may be further increased.

In another embodiment, the device according to the present invention further comprises a heater, wherein the controller is configured to control the heater based on a signal from the sensor to maintain a material in the fluid chamber in a liquid phase during operation. The controller is configured to maintain a material in the fluid chamber to a temperature above the melting point of said material. The controller controls the heater to supply sufficient heat to prevent the measured resistance parameter from crossing a pre-determined threshold.

In another embodiment, the controller is configured to:
receive a first signal from the sensor when a material in a first phase is present in the fluid chamber;
control the heater to heat up the material in the fluid chamber;
receive a second signal when material between the electrodes enters into a second phase;
compare the second signal to the first signal to determine a reference resistance parameter; and
control the heater by comparing the sensed signal to the reference resistance parameter.

The phase of the material is determined from the resistance signal from the sensor. In a first example, the first signal or data corresponds to a resistance-temperature curve of the solid material, while the second signal corresponds to a resistance-temperature curve of the liquid material. During initial heating, the controller determines from the recorded resistance-curve, a resistance value for the phase change of the material. The phase change is identified e.g. by a drop in the resistance as the material transitions from solid to liquid (or flows in between the electrodes under the influence of gravity).

The controller then stores the resistance value and applies it as a reference for controlling the heater, such that the sensed resistance is kept at the desired side of resistance value. This simple control scheme allows the material to be maintained in its liquid form during operation. Basically, during heating the reference is calibrated resulting in accurate phase control of the material regardless of the material applied. It will be appreciated that in another example the first signal may correspond to the liquid phase while the second signal corresponds to the solid phase.

In the above embodiment, the controller is configured for determining or identifying a phase change in the material in the fluid chamber by comparing the first and second signals. The first signal then corresponds to the resistance parameter as measured during the first phase of the material while the second signal corresponds to the resistance parameter of the material in the second phase. The phase change defines or forms a suitable reference for controlling the heater to maintain the material in the desired phase. The resistance of metals and alloys changes non-linearly when the material changes phases. This relatively abrupt change in the resistance-curve can identified to determine the phase change, e.g. the melting point. The present invention is particularly advantageous when the material is a semiconductor, which experiences an exponential transgression of the resistance during a phase change.

In another embodiment, the controller is configured to:
receive a first signal from the sensor when no material is present between the electrodes;
control the heater to heat up the material in the fluid chamber;
receive a second signal when fluid from the fluid chamber enters in between the electrodes;
compare the second signal to the first signal to determine a reference resistance parameter; and
control the heater by comparing the sensed signal to the reference resistance parameter.

Initially, the electrodes are free of material, which is present in solid form in the fluid chamber but unable to sink towards the electrodes under the influence of gravity. The resistance detector in this case detects a relatively constant first signal. The heater proceeds to supply heat to the material until the material progressing into its liquid phase. The liquid material then under the influence of gravity descends into contact with the electrodes, resulting in a relatively abrupt change in the resistance signal. By identifying this change in resistance between the electrodes, a phase change in the material can be determined. The heater can then be controller correspondingly to maintain the material in the desired phase, for example by maintaining the heater at its operational power level at the moment the phase change was determined.

In an embodiment, the sensor further comprises a resistance detector connected to the electrodes for sensing a first and a second resistance signal representative of the electrical resistance of the respectively the solid and liquid material between the electrodes, and wherein the controller is configured to identify a phase change in the material by comparing the first and second signals. Within the same phase, the resistance curve of a material is generally smooth or continuous, for example linear, polynomial, or arced. When transitioning between phases, the resistance changes relatively abruptly or irregularly. The controller is configured to detect this abrupt change e.g. from a change in the resistance curve's slope and/or its higher order derivatives.

Thereby, the controller is configured to determine a suitable reference resistance without further knowledge of the material in question.

It will be appreciated that nay manner of actuator may be applied for jetting the droplet, such as a Lorenz actuator, gravity-based actuator (drip system), pressure-based actuator, etc.

In another embodiment, the material of the fluid comprises a metal and wherein the fluid chamber body is arranged in a center of a coil, the coil being configured to carry an electrical current for inducing an inductive current in the material of the fluid for heating the material of the fluid. This inductive heater provides an efficient and compact heating system. The electrical current in the coil is controlled based on input from the sensor. By comparing the sensed resistance parameter to the reference, the controller sets or adjusts the coil's current to bring the material to its liquid phase and maintain the material in that phase.

In a further aspect, the present invention provides a printing system comprising a device according to the present invention. The printing system comprises a carriage holding a plurality of the jetting devices according to the present invention. The carriage is preferably translatable over a medium support surface to deposit liquid droplets over the surface of the medium.

The device according to the present invention comprises a fluid chamber body defining a fluid chamber and having an orifice extending from the fluid chamber to an outer surface of the fluid chamber element. A droplet of the fluid may be expelled from the fluid chamber through the orifice. An actuator is provided for generating a pressure force in the fluid for ejecting a droplet of the fluid from the fluid chamber and through the orifice. The fluid chamber body is made of a heat-resistant material.

As apparent from the requirements of a device for ejecting droplets of a hot fluid, the body forming the fluid chamber and holding the hot fluid needs to be heat resistant, in particular resistant to the heat of molten metals. Preferably the body is resistant to temperatures up to 3000 K, which enables to handle a large range of metals. Further, the material is preferably cost-effectively machinable. Also, it may be preferred that the material is resistant against corrosion by the molten metals. In an embodiment and due to the dimensions of the orifice, a capillary force may stimulate the flow into and through the orifice.

It is noted that, hereinafter, the fluid to be ejected from the device is described to be a molten metal. However, the device as claimed may as well be employed for jetting other relatively warm electrically conductive fluids.

In an embodiment, the fluid chamber body comprises an electrically conductive material, which may be advantageously employed with inductive heating of a metal to be jetted, since the material of the fluid chamber body will be heated resulting in a more efficient heating. In a particular embodiment, the material comprises graphite, which is cost-effectively machinable, has a high melting temperature and is wettable by e.g. alkali metals, sodium (Na), lithium (Li) and titanium (Ti).

In another embodiment, the material of the fluid chamber body is not electrically conductive. This may be advantageous for preventing an electrical actuation current flowing into the fluid chamber body, since such a flow into the body material would decrease a generated actuation force. In a particular embodiment, the fluid body chamber comprises boron-nitride (BN).

In an embodiment, the actuator comprises at least two electrically conductive electrodes, each electrode being arranged such that one end of each electrode is in electrical contact with the fluid in the fluid chamber. Thus, an electrical current may be generated in the fluid. The current generated in the fluid, which fluid is arranged in a magnetic field, may cause a force. A suitably arranged magnetic field in combination with a suitably generated current causes the force to be directed and to have an amplitude sufficient to force a droplet of fluid through the orifice.

In a particular embodiment, the electrodes are pin-shaped and wherein an electrode is arranged in a through hole in the fluid chamber body, the through hole extending from an outer surface into the fluid chamber. This provides a simple and effective arrangement for having the electrode making electrical contact with the fluid.

In a particular embodiment, an end of the electrode extending through the through hole is conically shaped and wherein an elastic force is exerted on the pin-shaped electrode such that a fluid tight connection between the electrode and the fluid chamber body is obtained. The conical shape being forced into the through hole results in a tight connection preventing leakage of the fluid from the fluid chamber through the holes accommodating the electrodes. Moreover, having the elastic force exerted on the electrode, when the fluid chamber body and/or the electrode expands/contracts due to relatively large temperature changes, the tight connection is maintained.

In an embodiment, the elastic force is provided by a spring, the spring being electrically isolated by a layer of electrically-isolating and heat-conducting material such as aluminium-nitride (AlN). The spring force is electrically isolated to prevent electrical current leakage to other parts of the device, while the heat conductivity is important to prevent that the springs become relatively warm, since the spring force would decrease due to such a high temperature of the spring.

In an embodiment, the magnetic field is provided by a permanently magnetized material, the magnetic field being concentrated at the fluid chamber using a magnetic concentrator made of magnetic field guiding material such as iron. In particular, the magnetic material is NdFeB and the magnetic material may be thermally isolated and/or cooled in order to prevent partial or total loss of magnetization due to a (too) high temperature of the material.

In an embodiment, the device further comprises a support frame. In this embodiment, the fluid chamber body is supported by the support frame by a support plate. The support plate may be rigid in at least one dimension and comprises a thermally-isolating and electrically-isolating material such as boron-nitride (BN) and/or alumina (Al2O3). Thus, the fluid chamber body is both thermally and electrically isolated from the remaining parts of the device. Considering the relatively high temperature that may occur in use, it is prevented that other parts become too warm and it is prevented that heat energy is lost to parts of the device that are not required to be heated. A similar consideration is applicable to the electrical isolation, preventing loss of electrical current and preventing to charge other parts of the device.

In an embodiment, the material of the fluid comprises a metal and the fluid chamber body is arranged in a center of a coil, the coil being configured to carry an electrical current for inducing an inductive current in the material of the fluid and/or the material of the fluid chamber body for heating the material of the fluid. The metal arranged in a current-carrying coil results in inductive heating of the metal. This is an effective and quick method for heating the fluid.

In another aspect, the present invention provides a method for determining a temperature of a material in a fluid chamber body of a device for ejecting droplets of an electrically conductive fluid, comprising the steps of:
passing an electrical current through material positioned between a pair of electrically conductive electrodes positioned such that the material when in liquid form is flowable between the electrodes;
determining a voltage signal between the electrodes;
determine a resistance parameter of the material from the voltage and the electrical current;
controlling heat supplied to the material in the fluid chamber body by comparing the determined resistance parameter to a reference. The current-voltage ratio is proportional to the resistance of the material between the electrodes. The resistance provides a measure for the phase of the material. A resistance parameter is determined from the current and the voltage, e.g. by selecting a voltage corresponding to a stabilized current portion of the actuation current pulse. Alternatively, the voltage-current ratio may be determined. The determined resistance parameter or voltage is compared to a reference value stored on the memory of the controller. The reference preferably corresponds to a phase transition of the material. The heater is then controlled to maintain the resistance parameter on a predefined side of the reference, such that the material maintains in the liquid phase.

In one embodiment, the method comprises the step of storing the reference, which comprises:
heating the material in the fluid chamber;
determine a value of the resistance parameter at which value a phase transition in the material occurs;
setting said value of the resistance parameter as the reference.

In another embodiment, the method further comprises jetting a droplet of the material from the fluid chamber.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 shows a perspective view of a part of an embodiment of the device according to the present invention;

FIG. 2a shows a cross-sectional view of a part of the embodiment of FIG. 1;

FIG. 2b shows a cross-sectional view of a part of the embodiment of FIG. 1;

FIG. 2c shows a cross-sectional view of a part of the embodiment of FIG. 1;

FIG. 3 shows a schematic control scheme of the part shown in FIG. 2b;

FIG. 4 shows a schematic diagram of a current pulse and voltage pulse applied by a controller in the device of FIG. 1;

FIGS. 5A, B shows a the part of FIG. 2b during different stages of the heating process;

FIG. 6 shows a diagram of a method for operating the device in FIG. 1;

FIG. 7a shows a perspective view of a part of the embodiment of FIG. 1;

FIG. 7b shows a perspective and partially cross-sectional view of a part of the embodiment of FIG. 1; and

FIG. 8 shows a perspective view of a part of the embodiment of FIG. 1.

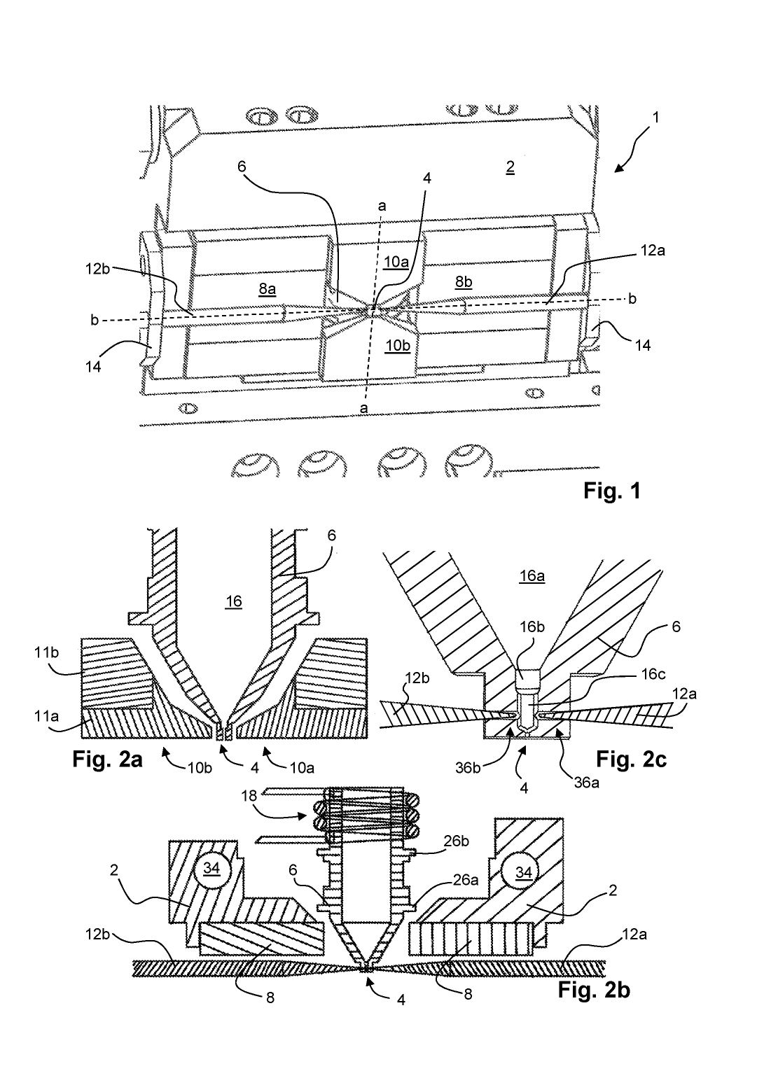

In the drawings, same reference numerals refer to same elements. FIG. 1 shows a part of a jetting device 1 for ejecting droplets of a relatively hot fluid, in particular a molten metal such as copper, silver, gold and the like. The jetting device 1 comprises a support frame 2, made of a heat resistant and preferably heat conductive material. As described hereinafter, the support frame 2 is cooled by a cooling liquid. A good heat conductivity increases the heat distribution through the support frame 2 and thereby increases a spreading of the heat. Further, the support frame 2 is preferably configured to absorb only a relatively small amount of heat from any of the heated parts of the jetting device 1. For example, the support frame 2 may be made of aluminum and be polished such that the aluminum reflects a relatively large amount, e.g. 95% or even more, of the heat radiation coming from any hot parts of the jetting device 1.

The jetting device 1 is provided with an ejection nozzle 4 through which a droplet of the fluid may be ejected. The nozzle or orifice 4 is a through hole extending through a wall of a fluid chamber body 6. In the fluid chamber body 6 a fluid chamber is arranged. The fluid chamber is configured to hold the fluid. Consequently, the fluid chamber body 6 needs to be heat resistant. Further, the fluid chamber body 6 is made such that the fluid, such as a molten metal, is enabled to flow over a surface, in particular an inner surface of the fluid chamber body 6, the inner surface forming a wall of the fluid chamber. Also, an inner wall of the through hole forming the orifice 4 needs to be wetting for the fluid in order to enable the fluid to flow through the orifice 4. It is noted that this even more relevant compared to known fluid jet devices such as inkjet devices, since molten metals generally have a relatively high surface tension, due to which molten metals tend to form beads. Such beads will generally not flow through a small hole such as the orifice 4. If the surface of the fluid chamber body 6 is wetting with respect to the fluid, the fluid will not tend to form beads, but will easily spread and flow over the surface and is thus enabled to flow into and through the orifice 4.

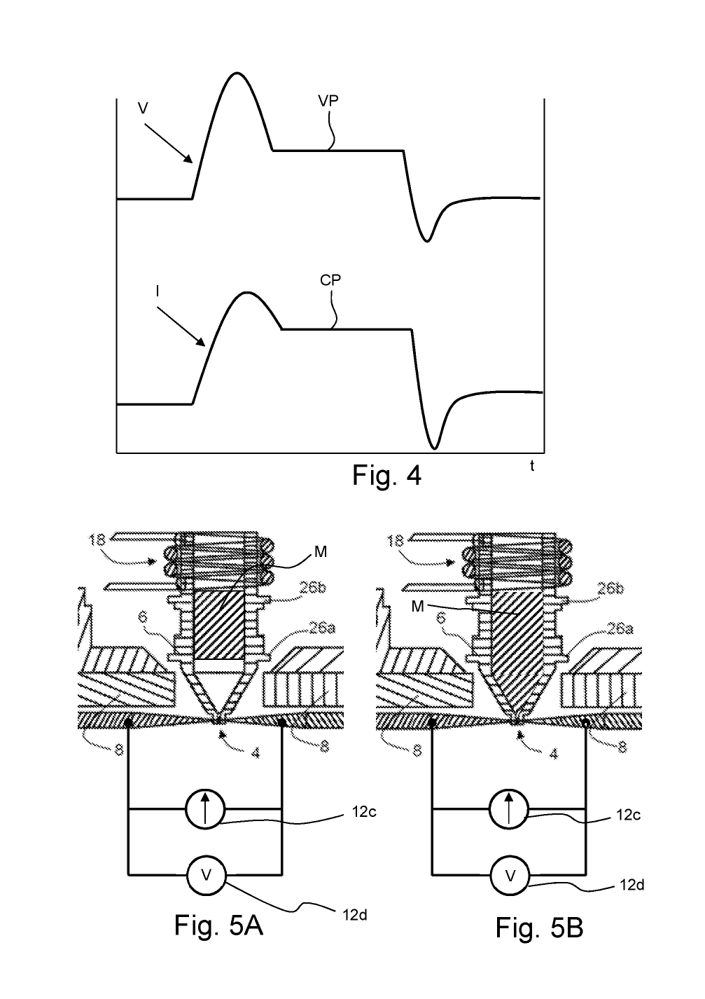

The fluid chamber body 6 is replaceably arranged as shown in more detail in e.g. FIGS. 2b and 4 as described hereinafter. Further, it is noted that the fluid chamber body 6 is preferably made cost-effectively such that a replaceable fluid chamber body 6 is economically feasible. Further, for example, as molten metals tend to chemically react with oxygen, after molten metals have been ejected from the fluid chamber body 6, the fluid chamber body 6 may not be reusable when left in air, because metal remaining in the fluid chamber will most probably react with oxygen. Oxidized metals tend to block the orifice 4 and/or change the wettability characteristics of the fluid chamber wall, thereby rendering the jetting device 1 unusable for further ejecting.

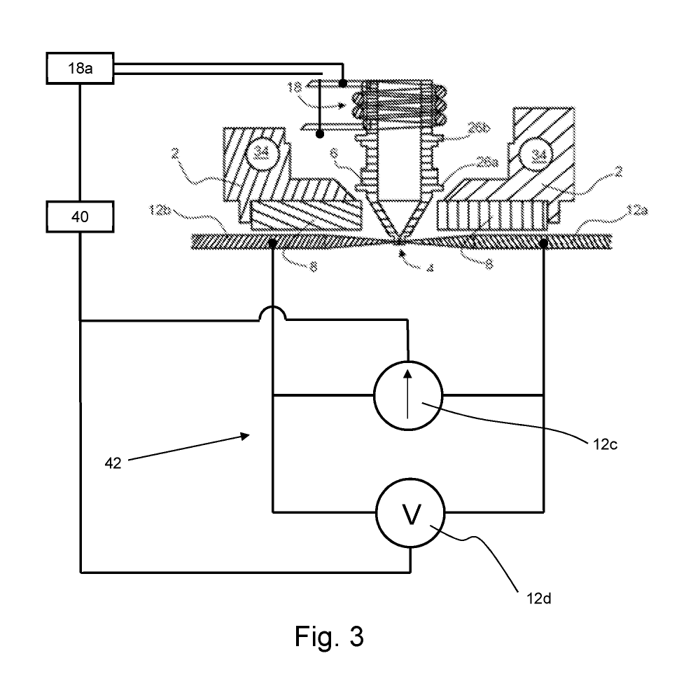

For ejecting droplets of molten metal, the jetting device 1 is provided with two permanent magnets 8a, 8b (hereinafter also referred to as magnets 8). The magnets 8 are arranged between two magnetic field concentrating elements 10a, 10b (hereinafter also referred to as concentrators 10) made of magnetic field guiding material such as iron. The jetting device 1 is further provided with two electrodes 12a, 12b (hereinafter also referred to as electrodes 12) both extending into the fluid chamber body 6 through a suitable through hole such that at least a tip of each of the electrodes 12 is in direct electrical contact with the molten metal present in the fluid chamber. The electrodes 12 are supported by suitable electrode supports 14 and are each operatively connected to a suitable electrical current generator (12C in FIG. 3) such that a suitable electrical current may be generated through the electrodes 12 and the molten metal present between the tips of the electrodes 12.

The magnets 8 and the concentrators 10 are configured and arranged such that a relatively high magnetic field is obtained at and near the position of the orifice 4, in particular in the molten metal at the location between the two respective tips of the two electrodes 12a, 12b. As indicated in the introductory part hereof, the combination of an electrical current and the magnetic field results in a force exerted on the molten metal, which may result in a droplet of molten metal being pushed through the orifice 4, thereby ejecting a droplet.

The permanent magnets 8 are thermally isolated from the fluid chamber body 6 at least to the extent that the temperature of the magnets 8 does not exceed a predetermined threshold temperature. This threshold temperature is predetermined based on the temperature above which the magnets 8 may partially or totally lose their magnetization. For example, using permanent magnets 8 made of NdFeB, such a threshold temperature may be about 80° C. In order to achieve such a low temperature, in an embodiment, the magnets 8 may also be actively cooled e.g. using suitable cooling means, such as a cooling liquid.

The electrodes 12 are made of a suitable material for carrying a relatively high current, while being resistant against high temperatures. The electrodes 12 may be suitably made of tungsten (W), although other suitable materials are contemplated.

FIGS. 2a-2c further illustrates the fluid chamber body 6 having the fluid chamber 16 as an interior space. FIG. 2a shows a cross-section of the embodiment illustrated in FIG. 1, which cross-section is taken along line a-a (FIG. 1). FIGS. 2b-2c show a cross-section of the embodiment illustrated in FIG. 1, which cross-section is taken along line b-b (FIG. 1). In FIG. 2a, the fluid chamber 16 is shown. The interior wall of the fluid chamber body 6 defining the fluid chamber 16 is in accordance with the present invention wetting with respect to the fluid to be ejected through the orifice 4. For example, the fluid chamber body 6 is made of graphite and the fluid to be ejected is molten titanium (Ti). In another embodiment, the fluid to be ejected is gold (Au), silver (Ag) or copper (Cu). These metals do not wet on graphite and therefore tend to form beads. Such beads cannot be ejected through the orifice 4 without application of an additional force such as a gas pressure. In accordance with the present invention, the interior wall forming the fluid chamber 16 is therefore suitably coated. In a particular embodiment, the coating comprises tungsten-carbide (WC, W₂C, W₃C). The coating may be provided by chemical vapor deposition (CVD), for example. A coating comprising tungsten-carbide is wetting for a large number of molten metals and is therefore very suitable. Other suitable embodiments of coatings include chrome-carbide (CrₓC_{y}). Chrome-carbide is wetting for copper (Cu) and has a relatively low melting temperature. So, although a suitable embodiment of a coating in accordance with the present invention, it is only suitable for use with a limited number of metals.

In an embodiment, at an outer surface, in particular around the orifice 4, the surface is non-wetting for the fluid to be ejected in order to prevent ejection disturbances due to fluid present around the orifice 4. If the above-mentioned wetting coating is also provided at the outer surface, it may be preferable to remove the wetting coating around the orifice 4.

Further, with reference to FIG. 2a and FIG. 1, it is shown that the concentrators 10a, 10b are each comprised—in the illustrated embodiment—of at least two parts. For example, the concentrator 10a comprises a first part 11a and a second part 11b. The first part 11a extends substantially in the direction of line a-a. The first part 11a has a form and shape such that the magnetic field is concentrated near the orifice 4. The second part 11b extends substantially in the direction of line b-b and is configured to guide the magnetic field of the magnets 8 to the first part 11a, thus resulting in the magnetic field of the magnets 8 being guided to and being concentrated at the orifice 4. Of course, the first and the second parts 11a, 11b may be separate elements or may each be a portion of a single element.

Now referring to FIGS. 2b and 2c, the support frame 2 and the magnets 8 are shown. In the illustrated embodiment, the support frame 2 is provided with cooling channels 34 through which a cooling liquid may flow for actively cooling of the support frame 2 and the magnets 8. An induction coil 18 is shown. The fluid chamber body 6 is arranged in a center of the induction coil 18 such that a current flowing through the induction coil 18 results in heating of a metal arranged in the fluid chamber 16. Due to such RF or HF heating the metal may melt and thus become a fluid. Such inductive heating ensures a power-efficient heating and no contact between any heating element and the fluid, limiting a number of (possible) interactions between elements of the jetting device 1 and the fluid.

In an embodiment the fluid chamber body 6 is made of a material that is heated by inductive heating. As above mentioned, this increases the heating efficiency and in particular decreases a time period needed for melting a metal present in the fluid chamber in a solid state.

In FIG. 2b, it is shown that the fluid chamber body 6 is provided with a first ridge 26a and a second ridge 26b. These ridges 26a, 26b are provided for enabling a supporting coupling suitable for easily replacing the fluid chamber body 6, as is shown in more detail in FIG. 4.

FIGS. 2b and 2c further show the two electrodes 12a, 12b each having a conically shaped end. These conically shaped ends extend into the fluid chamber 16 through suitable electrode passages 36a, 36b, respectively. In particular, referring to FIG. 2c, the fluid chamber 16 is divided in a fluid reservoir 16a, a fluid passage 16b and an actuation chamber 16c. The ends of the electrodes 12 are arranged such that the ends are in direct electrical contact with the metal fluid in the actuation chamber 16c. As apparent from FIG. 2c, the conically shaped tip end of each electrode 12a, 12b has a smaller diameter than the respective electrode passages 36a, 36b, while the diameter of the electrodes 12a, 12b increase to a diameter that is substantially larger than the diameter of the respective electrode passages 36a, 36b such that tip ends of the electrodes 12a, 12b can be arranged in the electrode passages 36a, 36b such that each electrode passage 36a, 36b may be liquid tightly closed by the respective electrodes 12a, 12b, while the end of the electrodes 12a, 12b are each in contact with the fluid. As apparent to those skilled in the art, the diameters of the electrodes 12a, 12b and the electrode passages 36a, 36b may be suitably selected such that the electrode ends do not touch each other, while fluid tight closure of the electrode passages 36a, 36b is obtained and maintained in operation.

In order to maintain a fluid tight closure of the electrode passages 36a, 36b, in an embodiment, a spring force is exerted on the electrodes 12, forcing the electrodes 12 into the fluid chamber 16. When the temperature of the fluid chamber body 6 and the electrodes 12 increases during operation, the dimensions of the different parts being made of different materials changes. Using the elastic force, e.g. provided by a spring, it is prevented that any change in diameter of the electrode passages 36a, 36b and any change in diameter of the electrodes 12 may result in leakage of fluid through the electrode passages 36a, 36b. It is noted that such a leakage results in a decrease of the pressure generated by an actuation and thus results in a decreased actuation efficiency.

FIG. 3 illustrates the heating control system of the device 1 in FIG. 1. The actuator for jetting droplets from the orifice 4 comprises the electrodes 12a, 12a positioned on opposite sides of a fluid passageway formed by the actuation chamber 16c. Fluid is thus able to pass between the electrodes 12a, 12b through the electrode passages 36a, 36b. The current generator 12c in FIG. 3 is configured to direct an actuation current pulse through the liquid via the electrodes 12a, 12b, such that a controlled or predefined current runs from one electrode 12a through the material to the other electrode 12b. The current generator 12c is connected to the controller 40. A voltage detector 12d is provided to detect the voltage drop between the electrodes 12a, 12b. The voltage detector 12 is arranged to transmit the detected voltage to the controller 40.

To determine the phase of the material between the electrodes 12a, 12b the controller 40 applies a predefined current to the electrodes 12a, 12b. In consequence, a voltage difference is established between the electrodes 12a, 12b. This voltage difference is detected by means of the voltage detector 12d and transmitted to the controller 40. The voltage generated by the applied current forms a measure for the resistance of the material between the electrodes 12a, 12b. The detected voltage is thus proportional to the resistance of the material. The resistance in turn is dependent on the temperature and/or phase of the material. As such, the voltage is representative of the temperature and/or phase of the material.

In an advanced example, the controller 40 determines a resistance value from the voltage and the current. The controller 40 then compares the determined resistance to a resistance-temperature curve or table for the applied material stored on its memory. Thereby, a value indication of temperature of the material may be obtained.

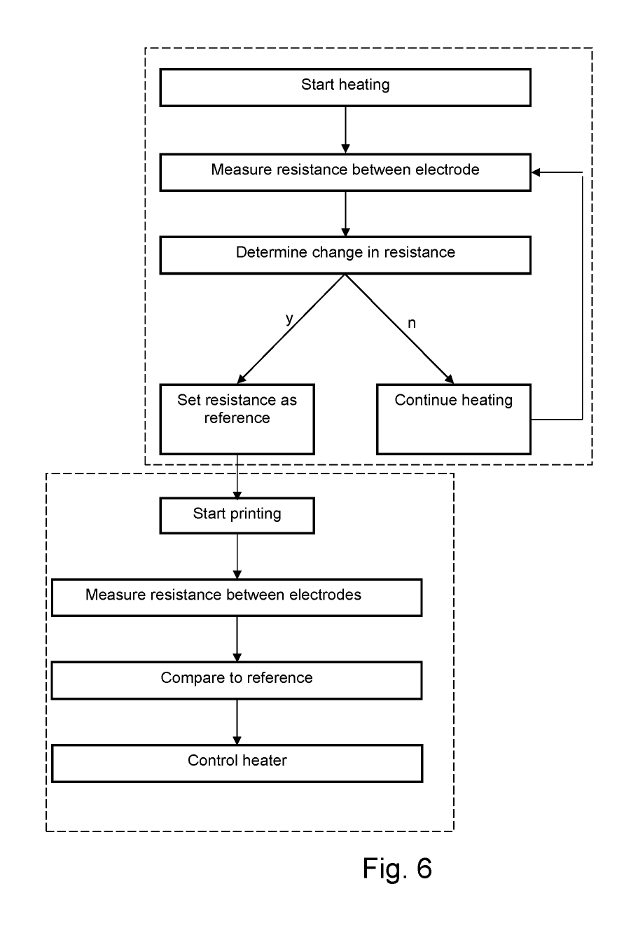

Optionally, the controller 40 may analyze the received voltage signal, for example by comparing the voltage to the current to determine a resistance or resistance of the material between the electrodes 12a, 12b. The controller 40 compares the received voltage signal to a reference stored on the memory of the controller 40. The reference may be a predetermined reference voltage corresponding to the melting point of the material in the fluid chamber 16. The reference may be selected from a look-up table on stored the memory using a material type input by an operator. Alternatively, the controller 40 may determine the reference during the heating process, as will be explained for FIGS. 5A, 5B, and 6.

Based on the comparison between the received signal and the stored reference, the controller 40 controls the induction generator 18a to transmit an alternating current through the induction coil 18. Preferably, the reference corresponds to a phase transition of the material, and the controller 40 controls the heater 18, 18a to maintain the material in the liquid phase. Control of the coil induction generator 18a may be done based on any known feedback mechanism, such as a feedback loop based on a difference between the reference and the detected voltage. In a basic example, the controller 40 determines a phase transition from the received voltage signal and maintains the inductive heating at its power level or value at the time of detecting the phase transition. Thereby, the present invention provides a single yet accurate control mechanism for maintaining the material in the fluid chamber 16 in a liquid state. The voltage detected by the sensor 42 thus provides an accurate measure which can be used to control the heater 18 to keep the material in a liquid state.

FIG. 4 illustrates an actuation current pulse I as applied by the current generator 12c to eject a liquid droplet from the orifice 4. The actuation pulse I comprises an rising edge (left) and a falling edge (right) with there in between a stabilized current portion CP. Peaks are present at the edges due to alinear or inductive effects present in the system. Likewise, the detected voltage V comprises a rising and a falling edge on either side of a stabilized voltage portion VP. The inductive effects in the system also deform the voltage signal V at the at edges. Therefore, it is preferred to measure the resistance signal V when the current signal I has stabilized. Advantageously, the actuation pulse I applied in the present invention comprises a constant current portion CP. In consequence, the recorded resistance signal V comprises a corresponding stabilized voltage portion VP. The controller 40 preferably applies the stabilized voltage portion VP to increase the accuracy. The constant current or voltage portion CP, VP lies in between the rising and falling edges of the applied pulse V, I.

FIG. 5 illustrates an embodiment of a method according to the present invention for determining the reference to which the resistance signal V is compared. When not in operation, the heater 18 is inactive resulting in the solidification of the material M in the fluid chamber 16. The electrodes 12a, 12b are free from the material M, which in its solid form is unable to pass downwards under the influence of gravity to the orifice 4. During start-up, the heater 18 is activated for heating the material M in the fluid chamber 16. A current I is applied to the electrodes 12a, 12b via the current generator 12c while the voltage detector 12d monitors the voltage between the electrodes 12a, 12b. Without conductive material M between the electrodes 12a, 12b, the value of the recorded voltage signal V will be substantially stabile. Upon reaching the melting point, the material M liquefies and passes between the electrodes 12a, 12b. The recorded voltage V will then change from the previously discussed value. By detecting this sudden change in the voltage signal V, a suitable reference value for the resistance signal V may be found. The heater 18 may then be controlled to maintain the voltage signal V substantially at or above the determined reference.

FIG. 6 illustrates the various steps of a method according to the present invention. The upper block illustrates the steps of the method for setting the reference while the lower block illustrates the method for controlling the heater during operation. It will be appreciated that within the present invention both methods may be applied independently from one another.

The method starts with the initial step of the controller 40 activating the heater 18 to heat the material M in the fluid chamber 16. An alternating current is transmitted from the coil induction generator 18a to the coil 18 to inductively heat the material. During heating, the controller 40 receives data from the sensor 42. The current generator 12c transmits a current to the electrodes 12a, 12b while the voltage detector 12d monitors the voltage across the electrodes 12a, 12b. Initially there may be no material M present between the electrodes 12a, 12b as explained with reference to FIGS. 5A-B. Alternatively, solid material M may be present between the electrodes 12a, 12b and during the initial heating of the solid material M, the voltage detector 12d then measures the resistance signal V for the solid material M. When sufficient heat has been applied to the material, M the material M transitions into the liquid phase. This incurs a sudden change in the resistance of the material M between the electrodes 12a, 12b. The detected resistance signal V changes accordingly. The controller 40 then derives a reference voltage or resistance from the resistance signal V corresponding to the phase transition. The determined reference is then stored in the controller's memory. By applying the above described reference calibration method, a suitable reference for the phase transition may be determined without any additional material information. The reference may further be compared to a look-up table to identify the material M type in the fluid chamber.

The lower block represents the heater control operation of the device according to the present invention. First a suitable reference is selected, either via the above described methods or from a reference-material type table stored on the controller 40. The controller 40 then continually or intermittently receives the resistance signal V from the sensor 42. The received resistance signal V is compared to the reference. Thereby, the phase of the material M may be determined. Further, the controller 40 may determine whether additional heating by the heater 18 is required. The coil current generated by the coil induction generator 18a is thus controlled by comparing the resistance signal V to the reference.

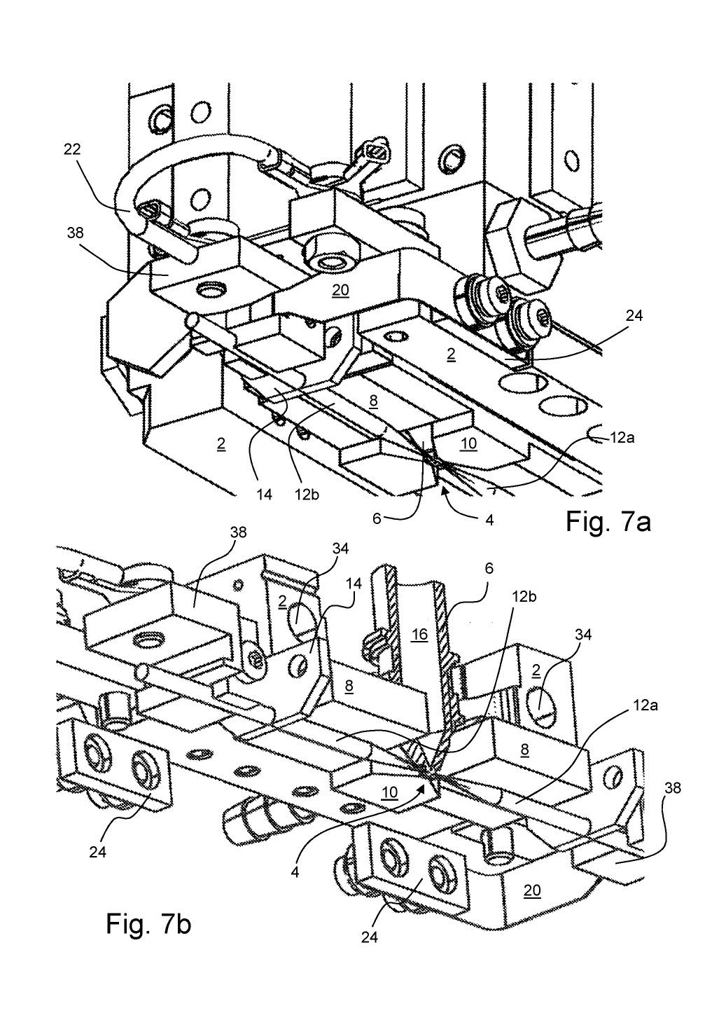

FIG. 7a illustrates an embodiment in which an elastic force is exerted on the electrodes 12 using a spring 20. The spring 20 is supported by the support frame 2, while an electrically isolating body 24 is arranged between the spring 20 and the support frame 2 for preventing that electrical current from the electrode 12b is enabled to flow through the spring 20 to the support frame 2. Further, the body 24 is thermally conductive in order to keep the spring 20 at a low temperature by the good thermal contact with the relatively cold support frame 2. It may be important to maintain the temperature of the spring 20 relatively low, since the spring force of the spring 20 may decrease, if the temperature becomes above a predetermined temperature, as is well known in the art.

A suitable material for the electrically isolating and thermally conductive body 24 may be aluminum-nitride (AlN).

The spring 20 is connected to a coupling element 38, the coupling element 38 further being connected to the electrode 12b. Thus, the spring 20 is enabled to exert its spring force on the electrode 12b through the coupling element 38. The coupling element 38 may further be employed to provide a suitable electrical coupling to the current generator, e.g. using an electrical conductive wire 22.

FIG. 7b shows a substantially similar perspective view as shown in FIG. 3a, except that a number of parts is removed and the fluid chamber body 6 is shown in cross-section, thereby showing the fluid chamber 16.

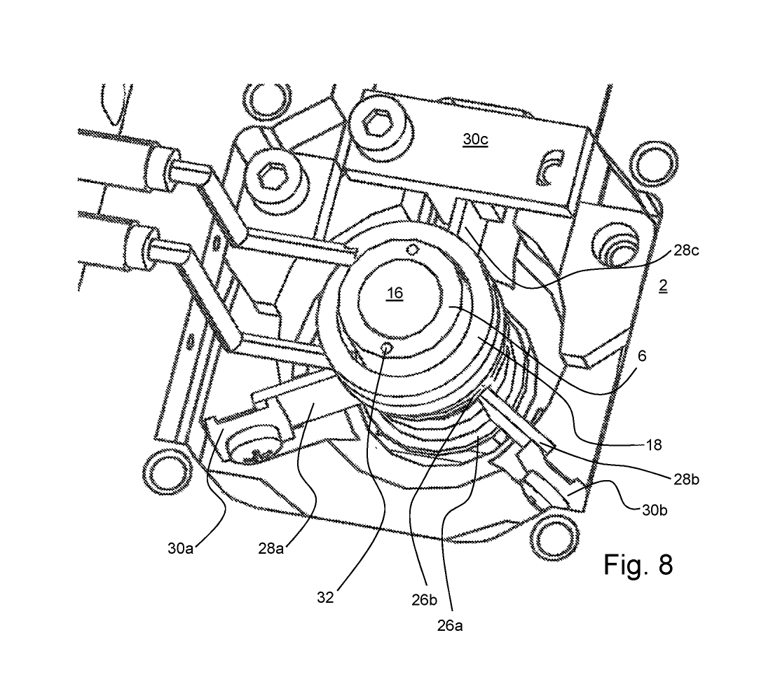

FIG. 8 shows a perspective top view of the support frame 2 supporting the fluid chamber body 6. Around the fluid chamber body 6 defining the fluid chamber 16 the inductive coil 18 is arranged. The fluid chamber body 6 is supported by three support elements 28a, 28b, 28c. The support elements 28a, 28b, 28c have a dimension substantially equal to a distance between the first ridge 26a and the second ridge 28b of the fluid chamber body 6. The three support elements 28a, 28b, 28c are each embodied as a rigid support plate. The three support elements 28a, 28b, 28c are arranged around the fluid chamber body 6 at angles of substantially 60° relative to each other. Thus, the fluid chamber body 6 may be clamped between the support elements 28a, 28b, 28c. The support elements 28a, 28b, 28c are clamped between the support frame 2 and respective clamps 30a, 30b, 30c, which allow the support elements 28a, 28b, 28c to be released both for easily removing and for easily introducing and positioning the fluid chamber body 6 such that the orifice 4 is positioned between the magnetic field concentrators 10. The support elements 28a, 28b, 28c preferably isolate the fluid chamber body 6 from the support frame 2 both electrically and thermally. Therefore, the support elements 28a, 28b, 28c may be suitable made of alumina (Al₂O₃) or boron-nitride (BN).

FIG. 8 further shows holes 32 in the wall of the fluid chamber body 6 which have a suitable size for introducing a suitable thermocouple (or any other suitable temperature sensing element) for enabling to determine an actual temperature of the fluid chamber body 6 for controlling heating of the fluid and/or fluid chamber body 6.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. A device for ejecting droplets of an electrically conductive fluid of a material, the device comprising:
a fluid chamber body defining a fluid chamber and having an orifice extending from the fluid chamber to an outer surface of the fluid chamber body; and
an actuator for ejecting a droplet of the fluid from the fluid chamber and through the orifice;
a controller configured for receiving a signal from a sensor and for determining a temperature parameter of the fluid from the received signal,
wherein the sensor is configured for sensing a resistance signal from the fluid and comprises a pair of spaced apart electrodes, wherein said electrodes are:
positioned such that fluid is flowable between the electrodes; and
arranged for passing an electrical current through fluid between the electrodes.

2. The device according to claim 1, wherein the sensor further comprises a resistance detector connected to the electrodes for sensing a resistance signal representative of the electrical resistance of the fluid between the electrodes.

3. The device according to claim 1, wherein the sensor further comprises:
a generator for generating at least one of an electrical current or voltage signal extending between the electrodes; and
a detector for sensing at least the other of the electrical current and voltage signal extending between the electrodes,
wherein the controller is configured for comparing the generated signal to the sensed signal to determine an electrical resistance parameter of the fluid between the electrodes.

4. The device according to claim 1, wherein the electrodes are positioned on opposite sides of a fluid passage.

5. The device according to claim 1, wherein the actuator comprises at least two electrically conductive actuation electrodes, each actuation electrode being arranged, such that one end of each actuation electrode is in electrical contact with the fluid in the fluid chamber.

6. The device according to claim 5, wherein the electrodes of the sensor are formed by the actuation electrodes.

7. The device according to claim 5, wherein the electrodes are pin-shaped and wherein an electrode is arranged in a through hole in the fluid chamber body, the through hole extending from an outer surface into the fluid chamber.

8. The device according to claim 5, wherein the controller is configured to:
transmit an actuation pulse through the electrodes for jetting a droplet of the fluid from the orifice, which actuation pulse comprises a constant current portion; and
determining the temperature parameter of the fluid by comparing the constant current portion to a signal portion received in response to the constant current portion.

9. The device according to claim 1, further comprising a heater, wherein the controller is configured to control the heater based on a signal from the sensor to maintain a material in the fluid chamber in a liquid phase.

10. The device according to claim 9, wherein the controller is configured to:
receive a first signal from the sensor when a material in a first phase is present in the fluid chamber;
control the heater to heat up the material in the fluid chamber;
receive a second signal from the sensor when material between the electrodes enters into a second phase;
compare the second signal to the first signal to determine a reference resistance parameter; and
control the heater by comparing the sensed signal to the reference resistance parameter.

11. The device according to claim 9, wherein the controller is configured to:
receive a first signal from the sensor when no material is present between the electrodes;
control the heater to heat up the material in the fluid chamber;
receive a second signal when fluid from the fluid chamber enters in between the electrodes;
compare the second signal to the first signal to determine a reference resistance parameter; and
control the heater by comparing the sensed signal to the reference resistance parameter.

12. The device according to claim 11, wherein the sensor further comprises a resistance detector connected to the electrodes for sensing a first and a second resistance signal representative of the electrical resistance of the respectively the solid and liquid phase of the material between the electrodes, and wherein the controller is configured to identify a phase change in the material by comparing the first and second signals.

13. The device according to claim 1, wherein the material of the fluid comprises a metal and wherein the fluid chamber body is arranged in a center of a coil, the coil being configured to carry an electrical current for inducing an inductive current in the material of the fluid for heating the material of the fluid.

14. A printing system comprising the device according to claim 1.

15. A method for determining a temperature of a material in a fluid chamber body of a device for ejecting droplets of an electrically conductive fluid, comprising the steps of:
passing an electrical current through material positioned between a pair of electrically conductive electrodes positioned such that the material when in liquid form is flowable between the electrodes;
determining a voltage signal between the electrodes;
determine a resistance parameter of the material from the voltage and the electrical current;
controlling heat supplied to the material in the fluid chamber body by comparing the determined resistance parameter to a reference.

16. The method according to claim 15, further comprising the step of jetting a droplet of the material out of an orifice of the fluid chamber.

17. The method according to claim 16, further comprising the step of applying an actuation pulse to the electrodes for jetting the droplet.

18. The method according to claim 17, further comprising the step of the droplets forming a metallic three-dimensional object on a substrate.

19. The method according to claim 16, wherein the step of controlling heat further comprises maintaining the material in the fluid chamber above its melting point.

20. The method according to claim 19, wherein the step of controlling heat further comprises maintaining the material in the fluid chamber at a temperature above and close to its melting point.
